(19) United States
(12) Patent Application Publication
(10) Pub. No.: US 2026/0095752 A1
(43) Pub. Date: Apr. 2, 2026

(54) ANOMALOUS ENTITLEMENT REQUEST DETECTION

(71) Applicant: T-Mobile USA, Inc., Bellevue, WA (US)

(72) Inventors: Anjani Deepthi Nandigam, Bothell, WA (US); Nilesh Ranjan, Sammamish, WA (US); Anthony Yiu, Newcastle, WA (US)

(21) Appl. No.: 18/901,590

(22) Filed: Sep. 30, 2024

(51) Int. Cl. H04W 8/20; H04L 41/16; H04W 12/121; H04W 12/72

(52) U.S. Cl. CPC H04W 8/205; H04L 41/16; H04W 12/121; H04W 12/72

(57) ABSTRACT

The present technology relates to detecting and responding to anomalous entitlement change requests in a telecommunication network. The method involves receiving, at an entitlement server of a telecommunication network provided by a mobile network operator (MNO), a request for a change to an entitlement of a subscriber on a wireless device. Network activity data related to the subscriber or the wireless device and collected by the MNO is received and used to analyze the legitimacy of the entitlement change request using a machine learning model trained on historical network activity data. If the request is deemed anomalous by the machine learning model, a security operation is performed to protect the subscriber.

### BACKGROUND

Fraudulent entitlement changes, such as Subscriber Identity Module (SIM) swaps, present a significant challenge for mobile network operators (MNOs). SIM swap fraud involves an unauthorized individual manipulating the system to transfer a victim’s phone number to a new SIM, thereby gaining control over the victim’s mobile identity. Once the fraudster has control of the phone number, they can intercept calls and text messages, including those containing two-factor authentication (2FA) codes sent by banks, email providers, and other services. This access allows the fraudster to reset passwords and gain unauthorized entry into the victim’s online accounts, including financial accounts, social media, and email. With control over these accounts, the fraudster can steal money, make unauthorized purchases, and gather sensitive personal information for further identity theft. The victim often remains unaware of the breach until significant damage has been done, making SIM swap fraud a particularly insidious and effective method of committing financial and identity fraud.

### BRIEF DESCRIPTION OF THE DRAWINGS

Detailed descriptions of implementations of the present invention will be described and explained through the use of the accompanying drawings.

FIG. 1 illustrates a wireless communications network that can implement aspects of the present technology.

FIG. 2 illustrates 5G core network functions (NFs) that can implement aspects of the present technology.

FIG. 3 illustrates an entitlement change in accordance with aspects of the present technology.

FIG. 4 illustrates anomalous entitlement request detection in accordance with aspects of the present technology.

FIG. 5 illustrates a method for detecting an anomalous entitlement request in accordance with aspects of the present technology.

FIG. 6 illustrates a machine learning (ML) system that can implement aspects of the present technology.

FIG. 7 illustrates components of a computing device that can implement aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Wireless network fraud is becoming more and more prevalent with fraudsters attempting to engage in activity on a wireless network under the identity of an unsuspecting victim. One such fraud attempt involves a fraudster engaging in a SIM swap, which requires tricking an MNO into transferring a victim’s phone number to a new SIM installed on a fraudster’s wireless device, thereby providing the fraudster control over the victim’s mobile identity. With the victim’s mobile identity, the fraudster can request access to the network and receive network services intended for the victim. For example, the fraudster can intercept calls and text messages, including those containing 2FA codes sent by banks, email providers, and other services. This access allows the fraudster to reset passwords and gain unauthorized entry into the victim’s online accounts, including financial accounts, social media, and email, and engage in fraudulent transactions.

Requests to access network services on a wireless device flow through an entitlement server of the telecommunications network. The entitlement server manages and validates the access rights and privileges of mobile subscribers, acting as an intermediary between the network and the subscriber’s device to ensure that only authorized users can access specific services and features. For example, to engage in SIM swap fraud, the entitlement server receives not only an entitlement request to allow the SIM swap but also one or more entitlement requests to enable one or more network services on the new SIM on the fraudster’s device. Thus, the entitlement server can provide a control point at which network fraud can be detected and mitigated. Unfortunately, techniques used to engage in fraud are constantly changing and can be difficult to detect within the plethora of legitimate entitlement requests received at the entitlement server.

To address these problems and others, the present technology relates to an ML model used to flag an entitlement request as potentially fraudulent or anomalous. The ML model can be trained on previous data collected by the network or the MNO in relation to previous entitlement requests and labeled as representing a typical, legitimate entitlement request or an anomalous, potentially fraudulent entitlement request. In response to a new entitlement request, data collected by the network or the MNO in the time period proceeding the entitlement request can be input to the trained ML model to determine if the entitlement request meets a threshold to be flagged as potentially fraudulent. The data input into the ML model can include data about the activity of a subscriber or a wireless device requesting the entitlement. The activity can include information about the subscriber’s or wireless device’s communication on the network or with the MNO. If the ML model determines that the entitlement request is anomalous and potentially fraudulent, a security operation can be performed to prevent fraud under the subscriber’s identity or using the wireless device.

The data input into the ML model can include data about the activity of the subscriber who is requesting the entitlement with the network or the MNO. For example, the data can include subscriber activity data collected by one or more other systems/servers of the network or the MNO. As specific examples, the subscriber activity data can include location data (e.g., collected by an Emergency 911 (E911) server of the network), previous entitlement requests by the subscriber (e.g., SIM swap or other network service requests), activity on a subscriber’s account with the MNO, or device information about one or more wireless devices on which the subscriber has been provisioned (e.g., from an Equipment Information Registry (EIR) of the network). In some cases, the subscriber activity data can include information collected by the network in association with a previous SIM swap associated with the subscriber (e.g., the requesting device and the target device’s location, the number of SIM swaps associated with the subscriber performed in a period of time, or information about the device onto which the subscriber was provisioned during any portion of the SIM swaps). Thus, the ML model can detect fraudulent or anomalous entitlement requests using subscriber activity data tracked by the network or the MNO, including entitlement requests made as part of a SIM swap fraud attempt.

The data input into the ML model can include data about the activity of the wireless device used to request the entitlement check with the network or the MNO. For example, the data can include device activity data collected by one or more other systems/servers of the network. As specific examples, the device activity data can include location data (e.g., collected by an E911 server of the device), previous entitlement requests made by the device (e.g., SIM swap or other network service requests), or device information (e.g., from an EIR of the network). In some cases, the device activity data can include information collected by the network is association with a previous SIM swap involving the device (e.g., location of the devices during the SIM swap or the number of SIM swaps made by the device). Thus, the ML model can similarly detect fraudulent or anomalous entitlement requests using device activity data tracked by the network or the MNO.

If the ML model determines that an entitlement request is anomalous or potentially fraudulent, one or more security operations associated with the subscriber or the device requesting the entitlement can be performed. For example, a notification can be provided to the subscriber to indicate that potentially fraudulent activity was detected using the subscriber’s identity. In some cases, the notification can be provided to the subscriber through a channel disassociated from the subscriber’s Mobile Station International Subscriber Directory Number (MSISDN), as any communication channels that run through the subscriber’s MSISDN may be accessible by a fraudster who has successfully completed a SIM swap of the subscriber’s identity. In other cases, the security operations can include rejecting or removing an entitlement to the subscriber or the wireless device. For example, the network can disallow the subscriber (e.g., on a currently provisioned SIM) or the wireless device (e.g., based on the device’s International Mobile Equipment Identity (IMEI)) from accessing text, voice, data, or other network services that could be used to engage in fraud using the subscriber’s identity. In other cases, the MNO can change a status of the wireless device (e.g., in the EIR) to blacklist the wireless device from accessing the network.

The ML model can also be retrained over time to detect and respond to new strategies for committing network fraud. For example, a subscriber or the MNO can indicate that a fraud attempt occurred using the subscriber’s identity and the subscriber or device activity data surrounding the fraud attempt can be used to update the ML model. Fraud patterns can also be shared across MNOs to enable different MNOs to detect fraud attempts on their network using the patterns determined by other MNOs. In this way, network operators can efficiently respond to fraud attempts across networks and time.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

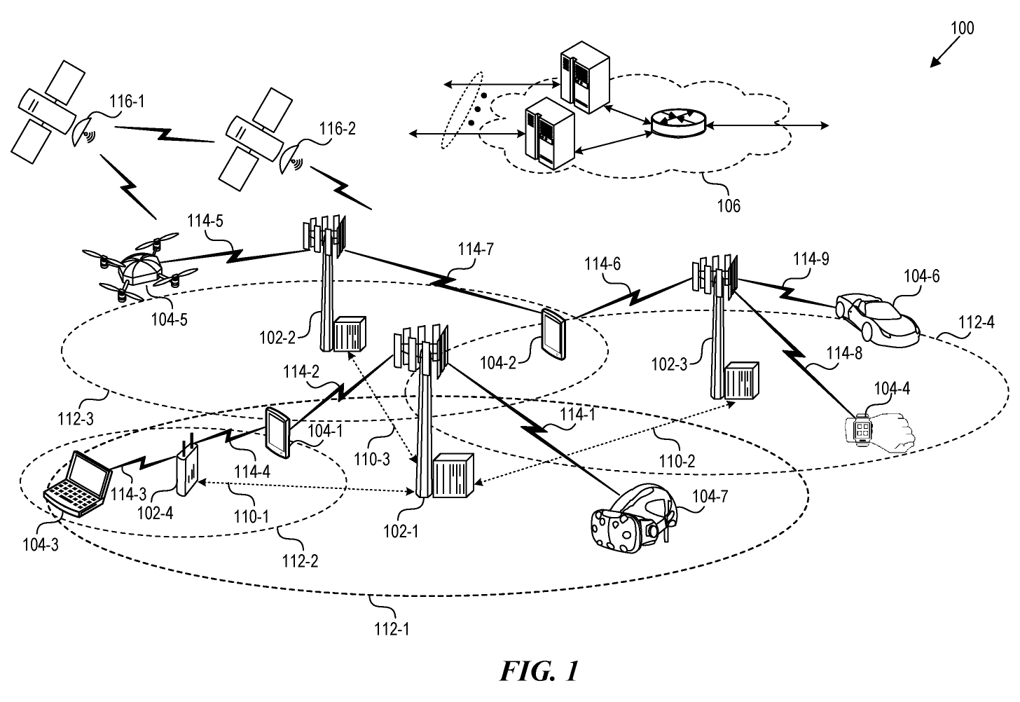

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR systems, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core NFs

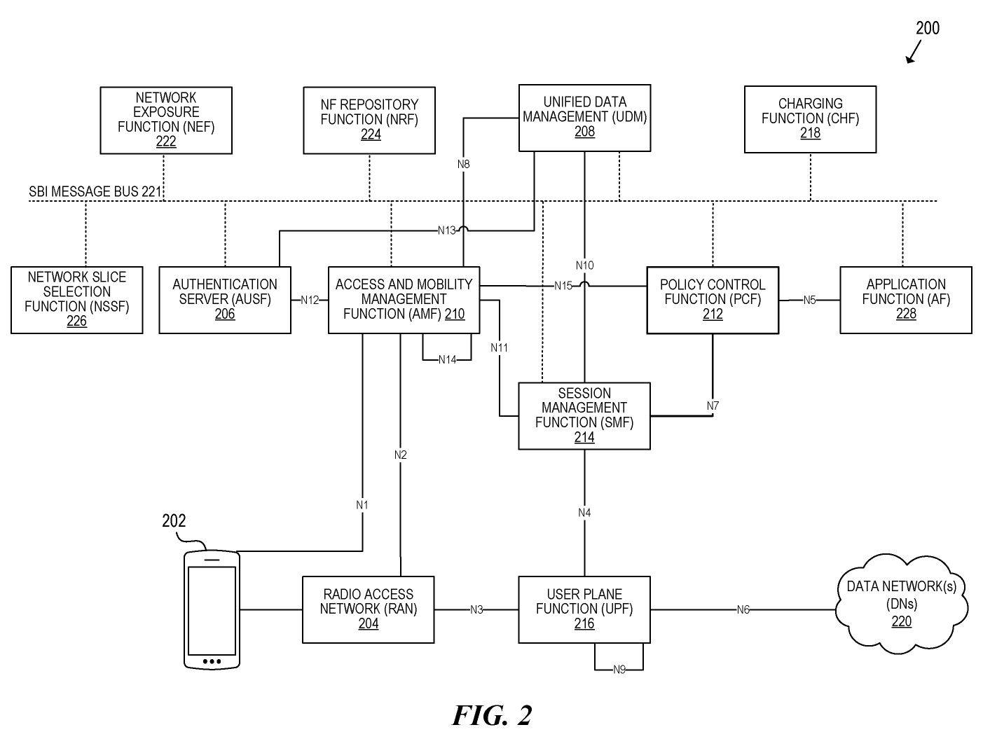

FIG. 2 is a block diagram that illustrates an architecture 200 including 5G core NFs that can implement aspects of the present technology. The present technology is discussed with respect to 5G networks for purposes of example and can similarly be implemented in networks utilizing other wireless communication technologies (e.g., 3G, 4G, LTE, or 6G). A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses Hypertext Transfer Protocol 2 (HTTP/2). The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given that a large number of wireless devices can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a data center, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Entitlement Change Request

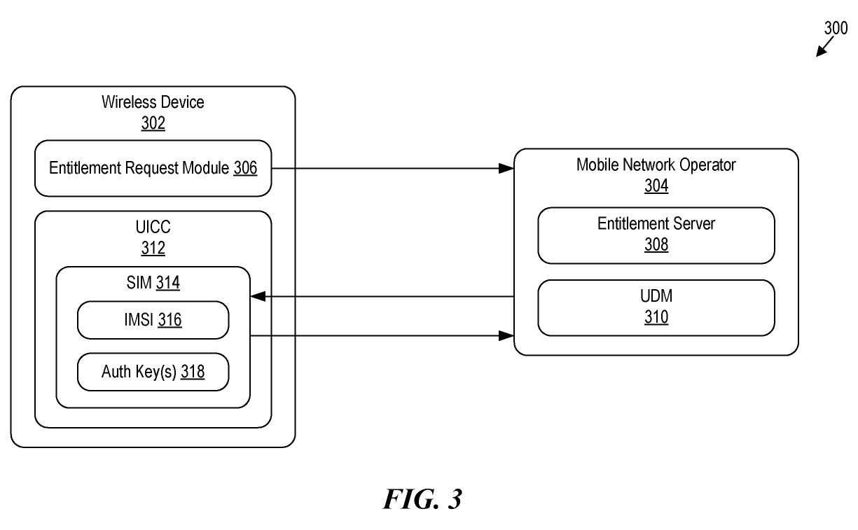

FIG. 3 illustrates an entitlement change 300 in accordance with aspects of the present technology. A wireless device 302 and an MNO 304 communicate with one another (e.g., through a wireless network provided by the MNO 304) to request an entitlement on the network. In other cases, the entitlement request can be initiated on a subscriber’s user account with the MNO 304. The wireless device 302 can include an entitlement request module 306 used to request an entitlement on the network from an entitlement server 308 operated by the MNO 304. For example, when a user attempts to use a service, such as connecting to the network, making a call, sending a text, or accessing mobile data, the device sends an entitlement request to the network’s entitlement server 308. This request typically includes the information about the wireless device 302 or the subscriber requesting the entitlement, such as the IMEI and (International Mobile Subscriber Identity (IMSI). The entitlement server 308 then cross-references this information with the operator’s database to confirm the user’s eligibility for the requested service. For example, the entitlement request or the accompanying information can be compared to subscriber information (e.g., stored in a UDM 310 of the MNO 304), including subscription information, or device information (e.g., stored in an EIR of the MNO 304) to determine whether a service should be provided to the subscriber on the wireless device 302. If the request is validated, the entitlement server 308 grants the necessary permissions, allowing the subscriber to access the service on the wireless device 302.

As a specific example, a SIM swap can be performed to provision, onto a Universal Integrated Circuit Card (UICC) 312 or the wireless device 302, a SIM 314 associated with the subscriber. In aspects, the UICC 312 can be an embedded UICC (eUICC) capable of being provisioned the SIM 314 (e.g., an embedded SIM (eSIM)) over the air. The SIM swap can be performed by contacting the MNO 304 and requesting the transfer of a phone number to a new SIM 314. This process can be initiated through customer service channels, such as a phone call or an online account. The MNO 304 can verify the identity of the subscriber through security questions, personal identification, or other authentication methods (e.g., using the entitlement server 308). Once the identity is confirmed, the MNO 304 deactivates the old SIM and activates the SIM 314, transferring the phone number and associated services. For example, the SIM 314 can include an IMSI 316 that the MNO 304 has associated with the subscriber and one or more authentication keys 318 used to access network services. The entitlement server 308 can update the UDM 310 to associate the SIM 314 (e.g., the IMSI 316) with the MSISDN of the subscriber (e.g., replacing any previous SIM associated with the MSISDN).

Once provisioned the SIM 314, the wireless device 302 can connect to the network using the SIM 314 to receive network resources. For example, the entitlement request module 306 can request an entitlement to receive/transmit texts, voice calls, or data or utilize other network resources as the subscriber using the SIM. The entitlement server 308 can receive this request and determine whether to approve the request. For example, the entitlement server 308 can compare the IMSI 316 to an IMSI associated with the subscriber in the UDM 310 to determine if the IMSI 316 is valid for the subscriber or query the EIR of the network with an IMEI of the wireless device 302 to determine whether the wireless device is blacklisted from receiving network services. The entitlement server 308 can further reference subscription information associated with the IMSI 316 to determine if the subscriber is entitled to the requested service. In yet other aspects, the entitlement server 308 can check other network servers/systems (e.g., location servers) to determine if the subscriber should be entitled to the network service on the wireless device 302 under the current conditions (e.g., in a particular location). If the subscriber is authorized to receive the service on the wireless device 302, the entitlement server 308 can entitle the wireless device 302 to these network services by providing an indication of the entitlement in the UDM 310. Then, in response to future network access requests, the wireless device 302 can be authorized to access the network services by referencing the UDM 310.

Thus, in the case of a SIM swap fraud attempt, a fraudster who successfully performs a SIM swap can have access to texts, voice calls, and other communications made to the subscriber on the network once becoming entitled by the entitlement server 308. This can provide the fraudster access to 2FA codes and onetime password (OTP) messages sent by banks, email providers, and other services. Thus, the fraudster can reset passwords and gain unauthorized entry into the subscriber’s accounts, including financial accounts, social media, and email. With control over these accounts, the fraudster can steal money, make unauthorized purchases, and gather sensitive personal information for further identity theft. Thus, the entitlement server 308 can provide a gateway through which fraud can be detected and stopped.

### Fraud Detection for an Entitlement Change Request

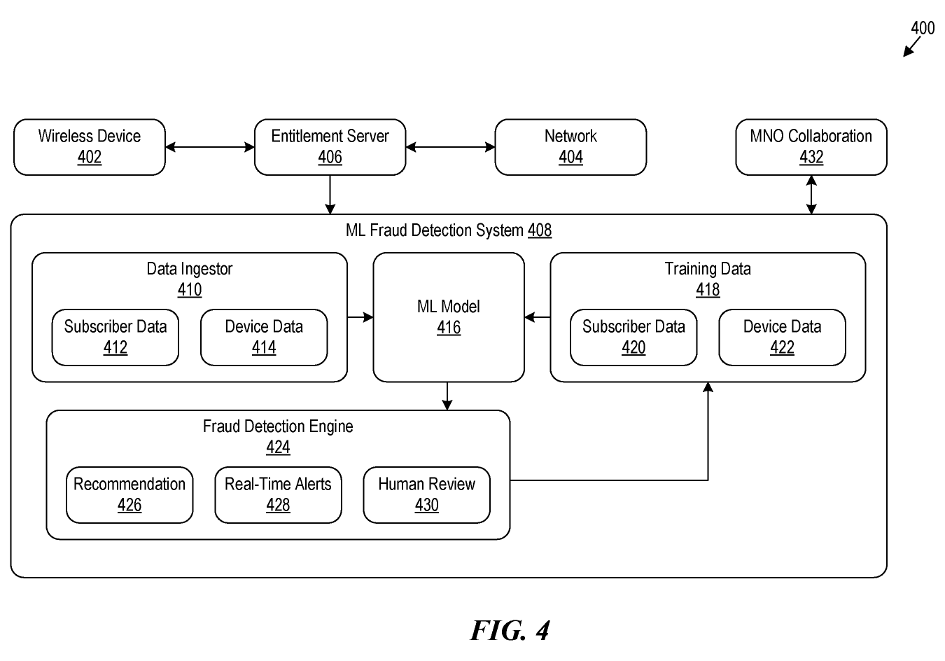

FIG. 4 illustrates anomalous entitlement request detection 400 in accordance with aspects of the present technology. As illustrated, a wireless device 402 requests an entitlement for network services on a telecommunications network 404 from an entitlement server 406. The entitlement can be requested in accordance with the entitlement process described with respect to FIG. 3. For example, the wireless device 402 can initiate an entitlement request for network services, the entitlement server 406 can receive information about the wireless device 402 or the subscriber from the network 404 to determine whether to accept or reject the entitlement request, and in response to accepting the entitlement request, the entitlement server 406 can store an indication that the subscriber is entitled to access the wireless service on the wireless device 402 within the network 404.

The entitlement server 406 further communicates with an ML fraud detection system 408, which can be used to detect anomalous entitlement requests that are potentially fraudulent. The ML fraud detection system 408 can compare data collected by the network or MNO about the subscriber or device requesting the entitlement to previous data collected during previous entitlement requests to determine if the current entitlement request is typical or anomalous.

As illustrated, the ML fraud detection system 408 includes a data ingestor 410 that can receive subscriber activity data 412 or device activity data 414 collected by the network 404 or the MNO during a time period prior to or concurrent with the entitlement request to the entitlement server 406. The time period from which the subscriber activity data 412 or the device activity data 414 is collected and provided to the ML fraud detection system 408 can vary. For example, in some instances, the time period can be a time period since a particular activity on the network has taken place (e.g., a SIM swap). In other cases, the time period can be a predefined time period, such as 1 minute, 1 hour, 1 day, or any other amount of time. The subscriber activity data 412 can be received from various portions of the network 404.

The subscriber activity data 412 can include data about any previous entitlement requests made by the subscriber (or associated with the subscriber’s identity) during the period of time. For example, the subscriber activity data 412 can include data about any SIM swaps requested by the subscriber, any requests for network services, such as text, call, or data services, or any request to adjust the security credentials of a subscriber (e.g., change a password on the subscriber’s account or alter the security procedures required to access the account or any other service on the network 404). For example, if a subscriber is engaging in multiple SIM swaps in a short period of time, this may be indicative that fraud is occurring because a SIM swap is typically only performed when a subscriber purchases a new device or subscribes to a new service plan. Moreover, if a subscriber is altering a security configuration of an account immediately after performing a SIM swap, this may indicate that a fraudster is attempting to access subscriber information and network resources provided to the subscriber more easily to facilitate a fraud attempt.

The subscriber activity data 412 can further include any data collected by the network in relation to these entitlement requests (e.g., data communicated or retrieved to approve or deny the entitlement request or data collected in temporal proximity to the entitlement request). This data can be used to detect if an entitlement request, or a pattern of multiple entitlement requests, is anomalous and potentially fraudulent. As will be discussed more generally with respect to other data that can be included in the subscriber activity data 412, this data related to the entitlement requests can be collected from any number of sources within the network 404 or associated with the MNO and can include various types of data.

In some embodiments, the subscriber activity data 412 can include location data from an E911 server or other server on the network 404 that stores location information. The subscriber activity data 412 can include location data from any device on which a SIM provisioned to the subscriber initiating the entitlement request was installed (e.g., location data from while the SIM was provisioned to the subscriber). In this regard, the location data can include data about a device associated with the subscriber before a SIM swap and data about a different device associated with the subscriber after the SIM swap. Thus, the subscriber activity data 412 can be used to determine if the location of a device that a SIM is swapped to (a target device) is in a different location from the device that the SIM is swapped from (a source device), which may be atypical of a legitimate SIM swap where a single user has both the source device and the target device in the same location. The subscriber activity data 412 can similarly include location data about where the subscriber logged into their user account with the MNO (e.g., to initiate a SIM swap). For example, if the target device of a SIM swap or other entitlement request is located in a different location than where the subscriber initiated the entitlement request through the subscriber’s account, this can be atypical of an expected entitlement request and potentially indicate fraud.

The subscriber activity data 412 can further include data about any devices that the subscriber was associated with (e.g., by the device’s SIM being provisioned to the subscriber) during the time period. For example, the subscriber activity data can include the status of these devices retrieved from an EIR of the network 404.The EIR can store the blacklist status of devices in association with their IMEI to determine if a device that has been associated with the subscriber has ever been blacklisted, potentially due to previously detected fraud attempts using the device.

In some embodiments, the subscriber activity data 412 can include any other data collected by the network 404 or the MNO. For example, the subscriber activity data 412 can include data received from an Identity and Access Management (IAM) system of the network 404 or MNO, a fraud detection system provided by the network 404 or the MNO, or any other server or user block of the network 404 or the MNO.

The device activity data 414 can include similar data to the subscriber activity data 412 but collected in relation to the wireless device 402 used to request the entitlement. The device activity data 414 can be collected from similar sources as the subscriber activity data 412. For example, the device activity data 414 can include location information about the wireless device 402 from the time period, information about any subscriber provisioned on the wireless device 402 (e.g., by a SIM swap) during the time period, any entitlement requests made by the wireless device 402 during the time period (e.g., SIM swaps or requests for network resources), any information collected by the network or the MNO in relation to those entitlement requests, a status of the wireless device 402, or any other information about the wireless device 402 collected by the network 404 or the MNO.

The ML fraud detection system 408 can include an ML model 416 that can be used to detect anomalous or potentially fraudulent entitlement requests based on the subscriber activity data 412 or the device activity data 414. The ML model 416 can be trained on training data 418 indicative of previous entitlement requests made on the network 404 or other networks. The each set of the training data 418 corresponding to a particular entitlement request can be tagged/labeled as indicating an anomalous or potentially fraudulent entitlement request or a typical and likely legitimate entitlement request. The ML model 416 can thus be trained based on the training data 418 in accordance with the tags/labels.

The training data 418 can include subscriber activity data 420 and device activity data 422, which is generally similar to the subscriber activity data 412 and the device data 414 but related to previous entitlement requests rather than a current entitlement request. In some cases, the training data 418 can include data only from previous entitlement requests by the wireless device 402 or a subscriber making the current entitlement request. In this way, the ML model 416 can detect deviations in the subscriber’s or wireless device’s own behavior, which may differ significantly from the behavior of other subscribers or wireless devices. In other cases, the training data 418 can include data from entitlement requests from other subscribers or other wireless devices on the network 404 or even subscribers or wireless devices on other networks. This can expand the training data 418 and allow for an accurate and general profile for a typical entitlement request.

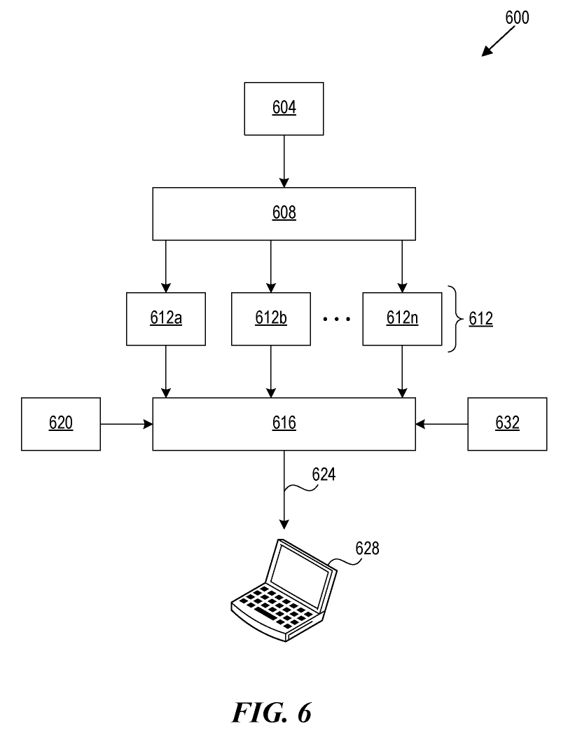

The ML model 416 can be implemented in any number of ways, as discussed in greater detail with respect to FIG. 6. In general, however, the ML model 416 can be trained on the training data 418 and, once trained, compare the subscriber activity data 412 or the device activity data 414 to the training data 418 to detect if the current entitlement request is anomalous. A fraud detection engine 424 can receive the values determined by the ML model 416 through the comparison and generate a recommendation 426. For example, the ML model 416 can output a score indicative of the deviation between the subscriber activity data 412 or the device activity data 414 and the training data 418. If the score meets a predetermined threshold, the fraud detection engine can determine that the current entitlement request is anomalous or potentially fraudulent and make the recommendation 426 accordingly. If the score does not meet the predetermined threshold, the recommendation 426 can indicate that the current entitlement request is typical or likely legitimate.

When an entitlement request is flagged as anomalous or potentially fraudulent by the recommendation 426, one or more security operations can be initiated to protect the subscriber and the network 404. In aspects, the security operations can include sending real-time alerts 428 to the subscriber whose identity was used to initiate the entitlement request. This notification can be sent through a secure channel that is not associated with the subscriber’s MSISDN, such as email, an alternative phone number, or the subscriber’s account with the MNO. This precaution ensures that the fraudster, who may have already gained control over the subscriber’s primary communication channels through a SIM swap, does not intercept the alert. The subscriber can respond to the notification, and the entitlement of the subscriber can be adjusted based on the response. For example, if the subscriber responds that the entitlement request was legitimately made by them, the entitlement request can be approved. If the subscriber responds that the entitlement request was fraudulent and not made by them, the entitlement request can be rejected, and one or more further security operations (e.g., removals of previously granted entitlements or an auto-reject of future entitlement requests) can be performed to stop the compromised identity from being used to engage in fraud.

The network 404 or MNO can take direct actions to prevent further fraudulent activity. This can include rejecting the entitlement request or removing existing entitlements associated with the subscriber or the wireless device. For instance, the network can block the subscriber’s current SIM or the device’s IMEI from accessing text, voice, data, or other network services. This can be done by adjusting an indication of the subscriber’s entitlements in the network 404 (e.g., at the UDM). Alternatively or additionally, the wireless device 402 can be prevented from accessing the network 404 or network services by blacklisting the wireless device 402 in the EIR of the network 404. This measure effectively cuts off the fraudster’s ability to exploit the compromised identity for malicious purposes.

To enhance the effectiveness of these security measures, the ML model 416 can be continuously retrained with new data. When a fraud attempt is confirmed, the subscriber or the MNO can provide detailed information about the incident, including subscriber and device activity data surrounding the fraud attempt. This data can correspond to the subscriber activity data 412 or the device activity data 414 used to detect that the entitlement request was fraudulent. The indication that the entitlement request was fraudulent can come from human review 430, such as a response to a notification (e.g., the real-time alerts 428) provided to the subscriber that a potentially fraudulent entitlement request was made using their mobile identity or from later reporting by the subscriber or the MNO. This data is used to update the ML model 416, improving its ability to detect similar fraudulent patterns in the future. In this way, the ML model 416 can also be updated for ever-evolving fraud schemes.

Additionally, fraud patterns, the training data 418, or the trained ML model 416 can be shared across different MNOs through MNO collaboration 432, enabling a collaborative approach to fraud detection and prevention. This sharing can be performed by storing the fraud patterns, the training data 418, or the trained ML model 416 in a server accessible to the various MNOs. By leveraging shared intelligence, MNOs can more efficiently identify and respond to emerging fraud strategies, thereby enhancing the overall security of the telecommunications ecosystem.

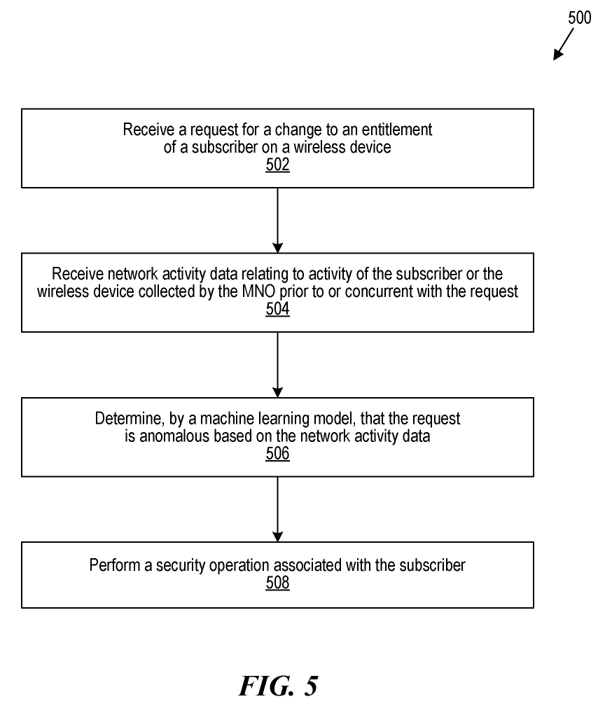

FIG. 5 illustrates a method 500 for detecting an anomalous entitlement request in accordance with aspects of the present technology. Although illustrated in a particular configuration, one or more operations of the method 500 may be omitted, repeated, or reorganized. Additionally, the method 500 may include other operations not illustrated in FIG. 5, for example, operations detailed in one or more other methods described herein.

At 502, a request to change the entitlement of a subscriber on a wireless device is received at an entitlement server of a telecommunication network managed by an MNO. The entitlement change can relate to a request from a subscriber to receive a network service on the wireless device. For example, the entitlement change can include a request to perform a SIM swap to provision a SIM associated with the subscriber on the device or a request to receive text, call, or data services on the device. The entitlement server is responsible for managing and validating these requests to ensure that only authorized changes are made to the subscriber’s entitlements.

At 504, the entitlement server receives network activity data from other servers within the telecommunication network. This data encompasses various activities of the subscriber or the wireless device collected by the MNO over a specific time period leading up to or concurrent with the entitlement change request. This comprehensive activity data provides a contextual background that helps in assessing the legitimacy of the request.

At 506, an ML model is used to determine that the request for the entitlement change is anomalous based on the network activity data. The model can be trained on historical data sets that include previous network activities associated with both typical and anomalous entitlement change requests. By learning from these tagged data sets, the model can identify patterns and deviations that indicate potential fraud or unauthorized actions. This continuous learning process ensures that the model remains effective in detecting new and evolving fraudulent strategies.

At 508, upon determining that the request is anomalous, a security operation is triggered to protect the subscriber. The security operation can involve notifying the subscriber of the suspicious activity through a secure channel, rejecting the entitlement change request, or temporarily suspending the subscriber’s or the device’s access to network resources to prevent further unauthorized actions.

### ML System

FIG. 6 illustrates an ML system 600 that can implement aspects of the present technology. The ML system 600 is implemented using components of a computer system. For example, portions of the ML system 600 are implemented on a computing device, server, or on a cloud computing system. Likewise, different embodiments of the ML system 600 include different and/or additional components and are connected in different ways and perform different functions. The ML system 600 is sometimes referred to as an ML module.

The ML system 600 includes a feature extraction module 608. In some embodiments, the feature extraction module 608 extracts a feature vector 612 from input data 604 (e.g., the input data described with respect to FIG. 4). The feature vector 612 includes features 612a, 612b, . . ., 612n. The feature extraction module 608 reduces the redundancy in the input data 604, for example, repetitive data values, to transform the input data 604 into the reduced set of features 612, for example, features 612a, 612b, . . ., 612n. The feature vector 612 contains the relevant information from the input data 604 such that events or data value thresholds of interest are identified by the ML model 616 by using a reduced representation. In some example embodiments, the following dimensionality reduction techniques are used by the feature extraction module 608: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 616 performs deep learning (also known as deep structured learning or hierarchical learning) directly on the input data 604 to learn data representations, as opposed to using task-specific algorithms. In deep learning, no explicit feature extraction is performed; the features 612 are implicitly extracted by the ML system 600. For example, the ML model 616 uses a cascade of multiple layers of nonlinear processing units for implicit feature extraction and transformation. Each successive layer uses the output from the previous layer as input. The ML model 616 thus learns in supervised (e.g., classification) and/or unsupervised (e.g., pattern analysis) modes. The ML model 616 learns multiple levels of representations that correspond to different levels of abstraction, wherein the different levels form a hierarchy of concepts. The multiple levels of representation configure the ML model 616 to differentiate features of interest from background features. In alternative example embodiments, the ML model 616, for example, generates the output 624 directly from the input data 604 without the need for feature extraction. The output 624 is provided to the computer device 628, which can be implemented as a server, computer, tablet, smartphone, etc. In some embodiments, the steps performed by the ML system 600 are stored in memory on the computer device 628 for execution.

In some cases, the ML model 616 is a Convolutional Neural Network (CNN). A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In some embodiments, the ML model 616 is a CNN that includes both convolutional layers and max pooling layers. For example, the architecture of the ML model 616 is “fully convolutional,” which means that variable sized sensor data vectors are fed into it. For convolutional layers, the ML model 616 specifies a kernel size, a stride of the convolution, and an amount of zero padding applied to the input of that layer. For the pooling layers, the ML model 616 specifies the kernel size and stride of the pooling.

In some embodiments, the ML system 600 trains the ML model 616, based on the training data 620, to correlate the feature vector 612 to expected outputs in the training data 620. As part of the training of the ML model 616, the ML system 600 forms a training set of features and training labels by identifying a positive training set of features that have been determined to have a desired property in question and, in some embodiments, forms a negative training set of features that lack the property in question.

The ML system 600 applies ML techniques to train the ML model 616 that, when applied to the feature vector 612, outputs indications of whether the feature vector 612 has an associated desired property or properties, such as a probability that the feature vector 612 has a particular Boolean property or an estimated value of a scalar property. In some embodiments, the ML system 600 further applies dimensionality reduction (e.g., via linear discriminant analysis (LDA), PCA, or the like) to reduce the amount of data in the feature vector 612 to a smaller, more representative set of data.

In some embodiments, the ML system 600 uses supervised ML to train the ML model 616, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 632 is formed of additional features, other than those in the training data 620, which have already been determined to have or to lack the property in question. The ML system 600 applies the trained ML model 616 to the features of the validation set 632 to quantify the accuracy of the ML model 616. Common metrics applied in accuracy measurement include Precision and Recall, where Precision refers to a number of results the ML model 616 correctly predicted out of the total it predicted, and Recall is a number of results the ML model 616 correctly predicted out of the total number of features that had the desired property in question. In some embodiments, the ML system 600 iteratively retrains the ML model 616 until the occurrence of a stopping condition, such as the accuracy measurement indication that the ML model 616 is sufficiently accurate, or a number of training rounds having taken place. In some embodiments, the validation set 632 includes data corresponding to confirmed locations, dates, times, activities, or combinations thereof. This allows the detected values to be validated using the validation set 632. The validation set 632 is generated based on the analysis to be performed.

### Computing System

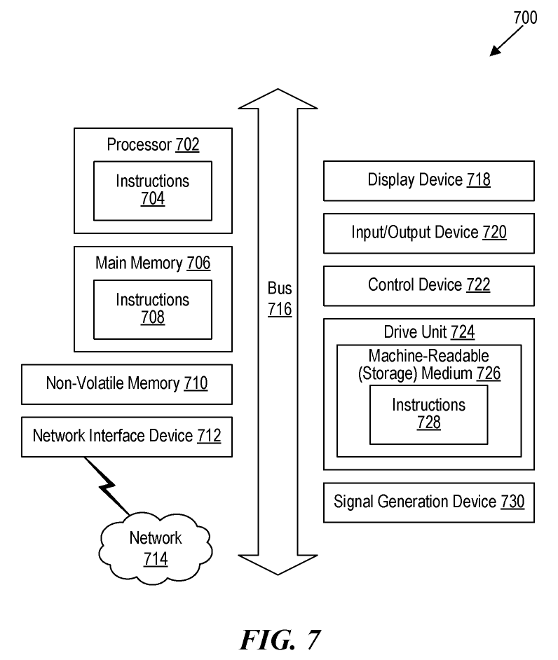

FIG. 7 is a block diagram that illustrates an example of a computing system 700 in which at least some operations described herein can be implemented. As shown, the computing system 700 can include one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computing system 700 is intended to illustrate a hardware device on which components illustrated or described relative to the examples of the figures and any other components described in this specification can be implemented.

The computing system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 700. In some implementations, the computing system 700 can be an embedded computing system, a system-on-chip (SOC), a single-board computing (SBC) system, or a distributed system such as a mesh of computing systems, or it can include one or more cloud components in one or more networks. Where appropriate, one or more computing systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system comprising:
at least one hardware processor; and
at least one non-transitory memory storing instructions that, when executed by the at least one hardware processor, cause the system to:
receive, at an entitlement server of a telecommunication network provided by a mobile network operator (MNO), a request for a change to an entitlement of a subscriber to the MNO on a wireless device;
receive, from one or more servers of the telecommunication network other than the entitlement server, subscriber activity data relating to activity of the subscriber collected by the MNO during a time period prior to or concurrent with the request for the change to the entitlement of the subscriber to the MNO on the wireless device,
wherein the subscriber activity data comprises subscriber identity module (SIM) swap data relating to a swap of a SIM provisioned to the subscriber from a first SIM provided to a previous wireless device to a second SIM provided to the wireless device, the SIM provisioned to the subscriber updatable over time;
determine, by a machine learning model and based on the subscriber activity data, whether the request for the change to the entitlement of the subscriber to the MNO on the wireless device is anomalous,
wherein the machine learning model is trained on previous sets of additional subscriber activity data collected by the MNO and related to previous requests for entitlement changes on the telecommunication network, each of the previous sets of additional subscriber activity data tagged as anomalous or typical of an expected entitlement change request; and
in response to determining that the change to the entitlement of the subscriber to the MNO on the wireless device is anomalous, perform a security operation associated with the subscriber.

2. The system of claim 1, wherein:
the subscriber activity data includes a location of the previous wireless device when the SIM provisioned to the subscriber corresponded to the first SIM provided to the previous wireless device and a location of the wireless device when the SIM provisioned to the subscriber corresponded to the second SIM provided to the wireless device.

3. The system of claim 1, wherein the subscriber activity data includes a number of swaps of the SIM provisioned to the subscriber during the time period.

4. The system of claim 1, wherein the instructions further cause the system to:
receive, from an equipment inventory registry of the telecommunication network, a blacklist status of respective ones of one or more wireless devices that were provided a respective third SIM that previously corresponded to the SIM provisioned to the subscriber,
wherein the subscriber activity data further comprises the blacklist status of the respective ones of the one or more wireless devices that were provided the respective third SIM.

5. The system of claim 1, wherein the instructions further cause the system to:
after accepting or rejecting the request for the change to the entitlement of the subscriber to the MNO on the wireless device, receive an indication that the request for the change to the entitlement of the subscriber to the MNO on the wireless device was fraudulent or legitimate; and
train the machine learning model using the subscriber activity data based on whether the request for the change to the entitlement of the subscriber to the MNO on the wireless device was indicated as fraudulent or legitimate.

6. The system of claim 1, wherein:
the security operation associated with the subscriber comprises transmitting, to the subscriber using a communication channel that is independent of a Mobile Station International Subscriber Directory Number (MSISDN) of the subscriber, an indication that the change to the entitlement of the subscriber to the MNO on the wireless device is anomalous.

7. The system of claim 1, wherein:
the security operation associated with the subscriber comprises removing, by the entitlement server and from the subscriber on the wireless device, access to one or more network services to which the subscriber was previously entitled on the wireless device.

8. The system of claim 1, wherein the instructions further cause the system to:
provide, to one or more other MNOs different from the MNO, at least one of the previous sets of additional subscriber activity data tagged as anomalous or typical of the expected entitlement change request.

9. At least one non-transitory, computer-readable storage medium storing instructions, which, when executed by at least one data processor of a system, cause the system to:
receive, at an entitlement server of a telecommunication network provided by a mobile network operator (MNO), a request for a change to an entitlement of a subscriber to the MNO on a wireless device;
receive, from one or more servers of the telecommunication network other than the entitlement server, network activity data relating to activity of the subscriber or the wireless device collected by the MNO during a time period prior to or concurrent with the request for the change to the entitlement of the subscriber to the MNO on the wireless device;
determine, by a machine learning model and based on the network activity data, whether the request for the change to the entitlement of the subscriber to the MNO on the wireless device is anomalous,
wherein the machine learning model is trained on previous sets of additional network activity data collected by the MNO and related to previous requests for entitlement changes on the telecommunication network, each of the previous sets of additional network activity data tagged as anomalous or typical of an expected entitlement change request; and
in response to determining that the change to the entitlement of the subscriber to the MNO on the wireless device is anomalous, perform a security operation associated with the subscriber.

10. The at least one non-transitory, computer-readable storage medium of claim 9, wherein:
the network activity data comprises subscriber identity module (SIM) swap data relating to a swap of a SIM provisioned to the subscriber from a first SIM provided to a previous wireless device to a second SIM provided to the wireless device, the SIM provisioned to the subscriber updatable over time.

11. The at least one non-transitory, computer-readable storage medium of claim 9, wherein:
receiving, from an emergency 911 (E911) server of the telecommunication network, one or more locations of the wireless device during the time period,
wherein the network activity data further comprises the one or more locations of the wireless device during the time period.

12. The at least one non-transitory, computer-readable storage medium of claim 9, wherein the network activity data includes a number of swaps of a SIM provisioned to the subscriber during the time period.

13. The at least one non-transitory, computer-readable storage medium of claim 9, wherein the network activity data includes a number of SIM swaps performed by the wireless device during the time period.

14. The at least one non-transitory, computer-readable storage medium of claim 9, wherein the instructions further cause the system to:
receive, from an equipment inventory registry of the telecommunication network, a blacklist status of respective ones of one or more wireless devices that were provided a SIM provisioned to the subscriber, the SIM provisioned to the subscriber updatable over time,
wherein the network activity data further comprises the blacklist status of the respective ones of the one or more wireless devices that were provided the SIM provisioned to the subscriber.

15. The at least one non-transitory, computer-readable storage medium of claim 9, wherein the instructions further cause the system to:
after accepting or rejecting the request for the change to the entitlement of the subscriber to the MNO on the wireless device, receive an indication that the request for the change to the entitlement of the subscriber to the MNO on the wireless device was fraudulent or legitimate; and
train the machine learning model using the network activity data based on whether the request for the change to the entitlement of the subscriber to the MNO on the wireless device was indicated as fraudulent or legitimate.

16. The at least one non-transitory, computer-readable storage medium of claim 9, wherein:
the security operation associated with the subscriber comprises transmitting, to the subscriber using a communication channel that is independent of a Mobile Station International Subscriber Directory Number (MSISDN) of the subscriber, an indication that the change to the entitlement of the subscriber to the MNO on the wireless device is anomalous.

17. The at least one non-transitory, computer-readable storage medium of claim 9, wherein:
the security operation associated with the subscriber comprises removing, by the entitlement server and from the subscriber on the wireless device, access to one or more network services to which the subscriber was previously entitled on the wireless device.

18. The at least one non-transitory, computer-readable storage medium of claim 9, wherein the instructions further cause the system to:
provide, to one or more other MNOs different from the MNO, at least one of the previous sets of additional network activity data tagged as anomalous or typical of the expected entitlement change request.

19. A method comprising:
receiving, at an entitlement server of a telecommunication network provided by a mobile network operator (MNO), a request for a change to an entitlement of a subscriber to the MNO on a wireless device;
receiving, from one or more servers of the telecommunication network other than the entitlement server, network activity data relating to activity of the subscriber or the wireless device collected by the MNO during a time period prior to or concurrent with the request for the change to the entitlement of the subscriber to the MNO on the wireless device;
determining, by a machine learning model and based on the network activity data, that the request for the change to the entitlement of the subscriber to the MNO on the wireless device is anomalous,
wherein the machine learning model is trained on previous sets of additional network activity data collected by the MNO and related to previous requests for entitlement changes on the telecommunication network, each of the previous sets of additional network activity data tagged as anomalous or typical of an expected entitlement change request; and
in response to determining that the change to the entitlement of the subscriber to the MNO on the wireless device is anomalous, performing a security operation associated with the subscriber.

20. The method of claim 19, wherein:
the network activity data comprises subscriber identity module (SIM) swap data relating to a swap of a SIM provisioned to the subscriber from a first SIM provided to a previous wireless device to a second SIM provided to the wireless device, the SIM provisioned to the subscriber updatable over time.
